(19) United States
(12) Patent Application Publication
(10) Pub. No.: US 2005/0133539 A1
(43) Pub. Date: Jun. 23, 2005

(54) Fluid dispenser member

(75) Inventor: Firmin Garcia, Evreux (FR)

Correspondence Address: SUGHRUE MION, PLLC, 2100 PENNSYLVANIA AVENUE, N.W., SUITE 800, WASHINGTON, DC, 20037, US

(73) Assignee: VALOIS SAS

(21) Appl. No.: 11/016,751

(22) Filed: Dec. 21, 2004

Related U.S. Application Data
(60) Provisional application No. 60/561,511, filed on Apr. 13, 2004.

(30) Foreign Application Priority Data
Dec. 22, 2003 (FR) FR-03/15192

(51) Int. Cl. G01F 11/06

(52) U.S. Cl. 222/321.7

(57) ABSTRACT

A fluid dispenser member designed to be associated with a fluid reservoir (50) and comprising:
a chamber (1) in which the fluid is put under pressure, the chamber being provided with an inlet valve (161, 38) and with an outlet;
a dispensing orifice (25);
a main piston (133) in leaktight sliding contact inside a main cylinder (242) for the purpose of causing the volume of the chamber to vary;
a pusher (20) that can be actuated to generate relative movement between the main piston and the main cylinder; and
a differential piston (31, 32, 33) in leaktight sliding contact inside the pusher for the purpose of selectively unmasking the outlet of the chamber;
said dispenser member being characterized in that it further comprises stroke-limiting means (28, 39) for limiting the stroke of the differential piston in the pusher, said stroke-limiting means being provided between the pusher and the differential piston.

### CROSS REFERENCE TO RELATED APPLICATION

This application claims the benefit under 35 U.S.C. §119(e) of pending U.S. provisional patent application Ser. No. 60/561,511, filed Apr. 13, 2004, and priority under 35 U.S.C. §119(a)-(d) of French patent application No. FR-03.15192, filed Dec. 22, 2003.

### TECHNICAL FIELD

The present invention relates to a fluid dispenser member that is generally designed to be associated with a fluid reservoir so as to constitute therewith a fluid dispenser. It is a dispenser member that is generally actuated manually by means of a user's finger. The fluid is dispensed in the form of a sprayed stream of fine droplets, a continuous trickle, or a dollop of fluid, in particular for viscous fluids, such as cosmetic creams. Such a fluid dispenser member can, in particular, be used in the fields of perfumes, cosmetics, or indeed pharmaceuticals, for dispensing fluids of various viscosities.

The present invention relates more particularly but not exclusively to a type of dispenser member that can be referred to as a “pusher-pump”. That name can be explained by the fact that the dispenser member comprises a pusher that not only forms a dispensing orifice but also defines a portion of a fluid chamber inside which fluid is selectively put under pressure. When the dispenser member is a pump, that chamber is a pump chamber. A particularity of such a pusher-pump lies in the fact that an inside surface of the pusher, which surface is substantially cylindrical in general shape, serves as a leaktight slide cylinder for a piston that moves in leaktight contact inside said cylinder, thereby selectively unmasking the dispensing orifice. In general, the piston is a piston of the differential type which moves in response to variation in the pressure of the fluid inside the chamber. The differential piston should be distinguished from the main piston which is caused to move by actuating the pusher. Thus, such a pusher-pump includes a differential piston and a main piston, which pistons can move in leaktight contact in respective cylinders. The main cylinder for the main piston can also be formed by the pusher.

### BACKGROUND OF THE INVENTION

That applies in particular in the pump described in Document WO 97/23304. The pusher has a push wall on which pressure is exerted by means of a finger for the purpose of actuating the pusher. In addition, the pusher has a skirt that extends downwards from the push wall. Said skirt forms a first leaktight slide cylinder for a differential piston and a main second cylinder for the main piston of the pump. The differential piston is dissociated from the main piston. The differential piston is urged away from the push wall by a spring that serves both as a return spring and as a precompression spring. The slide cylinder for the differential piston is provided with an outlet duct that leads to a nozzle received in a recess formed in the skirt of the pusher. The nozzle forms a dispensing orifice via which the fluid is discharged from the dispenser member. In addition, the recess formed by the skirt is provided with a swirl system which co-operates with the nozzle to entrain the fluid in a swirling movement before it is discharged through the dispensing orifice. The swirl system is conventionally made up of one or more tangential swirl channels opening out into a swirl chamber accurately centered on the dispensing orifice. The swirl system is in the form of a network recessed into the recess in the skirt. The recessed network is then associated with the separate nozzle that comes to isolate the swirl channels and the chamber. Thus, the slide cylinder of the differential piston is in the form of a cylindrical surface interrupted only at the outlet channel. When the pusher is pressed, the main piston rises up inside the main cylinder of the pusher, thereby causing the differential piston to move by sliding in leaktight manner inside the differential cylinder. That causes the spring to be compressed: the differential piston then moves upwards towards the push wall of the pusher. The active sealing lip of the differential piston, which lip is directly in contact with the fluid, slides in the bottom portion of the cylinder that is situated below the outlet channel. As soon as the differential piston reaches the outlet duct, the fluid put under pressure in the chamber is delivered from the chamber through said duct and reaches the nozzle, where it is swirled and discharged through the dispensing orifice.

The pump of Document WO 97/23304 is made up of five essential component elements, namely a body designed to be associated with a fluid reservoir, the pusher, a ball forming an inlet valve member, the differential piston, and the nozzle. The body forms the main piston.

In the prior-art document, the differential piston is pushed by the return and precompression spring against the body which thus forms a rest abutment for the differential piston. When the pressure rises in the chamber, the differential piston leaves its abutment contact on the body and moves upwards towards the dispensing wall so as to uncover the outlet duct which leads to the nozzle. Consequently, the rest position of the differential piston is directly dependent on the body.

### SUMMARY OF THE INVENTION

An object of the present invention is to define a dispenser member in which the displacement of the differential piston is completely independent from the body.

To achieve this object, the present invention proposes a fluid dispenser member designed to be associated with a fluid reservoir and comprising: a chamber in which the fluid is put under pressure, the chamber being provided with an inlet valve and with an outlet; a dispensing orifice; a main piston in leaktight sliding contact inside a main cylinder for the purpose of causing the volume of the chamber to vary; a pusher that can be actuated to generate relative movement between the main piston and the main cylinder; and a differential piston in leaktight sliding contact inside the pusher for the purpose of selectively unmasking the outlet of the chamber; said dispenser member being characterized in that it further comprises stroke-limiting means for limiting the stroke of the differential piston in the pusher, said stroke-limiting means being provided between the pusher and the differential piston. Thus, the differential piston is connected to the pusher in such a manner that its displacement is solely dependent on its interaction with the pusher, and no longer with the body. In this way, the pusher and the differential piston together constitute an independent entity which can be mounted on the body in a single operation. In the above-mentioned prior-art document, the differential piston does not really dependent on the pusher or on the body, so assembling the pump is relatively complicated. With a differential piston contained within the pusher, assembling the dispenser member is much simpler.

In an advantageous embodiment, the pusher comprises a push wall that can be pressed to actuate the pusher along an actuating axis, and a substantially cylindrical peripheral skirt, the differential piston being in leaktight sliding contact with the slide cylinder formed by the inside surface of the skirt. The stroke-limiting means advantageously comprise a retaining member formed at the push wall and a fastening element formed by the differential piston, said fastening element being in engagement with the retaining member so as to enable the differential piston to move axially over a limited stroke between a high abutment and a low abutment. The retaining member is advantageously provided with at least one retaining profile, and the fastening element is provided with at least one fastening head suitable for coming into engagement with said at least one retaining profile in the low abutment position. The push wall advantageously has a push outside surface and an inside surface, the fastening element coming into high abutment against said inside surface. The stroke-limiting means are thus formed by the pusher, at its push wall, together with the differential piston.

In an advantageous embodiment, the differential piston has a disk defining an outer periphery forming at least one sealing lip in leaktight sealing contact with the cylinder of the skirt, the fastening element extending from the disk towards the push wall. The differential piston advantageously has an axial rod co-operating with the valve seat for forming said inlet valve therewith.

In another aspect of the invention, the differential piston is urged by spring means which are formed integrally with the pusher. The spring means advantageously comprise elastically deformable tabs.

In another aspect of the invention, the dispenser member has a return spring urging the pusher into the rest position, said spring being formed integrally with the pusher.

### BRIEF DESCRIPTION OF THE DRAWINGS

The invention is described more fully below with reference to the accompanying drawings which show embodiments of the invention by way of non-limiting example.

In the figures:

FIG. 1 is a vertical section view through a first embodiment of the dispenser member in the rest state, associated with a fluid reservoir that is shown merely in part;

FIG. 2 is a view similar to FIG. 1, in the actuated position;

FIG. 3 is a vertical section view similar to the view of FIGS. 1 and 2, showing another embodiment of the invention, in the rest position; and

FIG. 4 is a view similar to FIG. 3, in the actuated position.

### DETAILED DESCRIPTION OF THE INVENTION

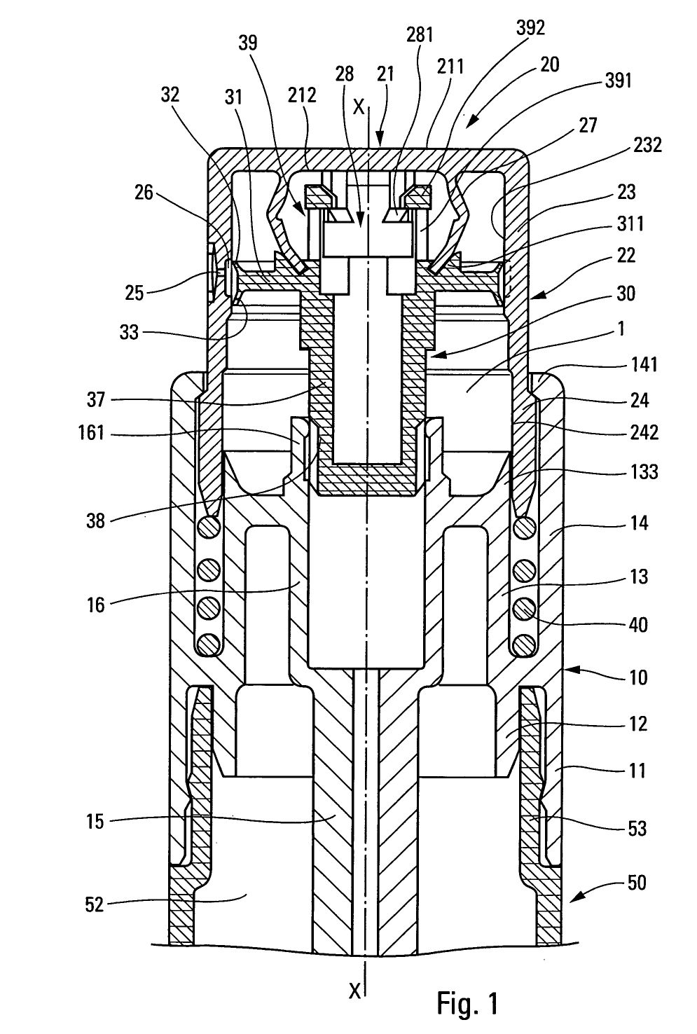

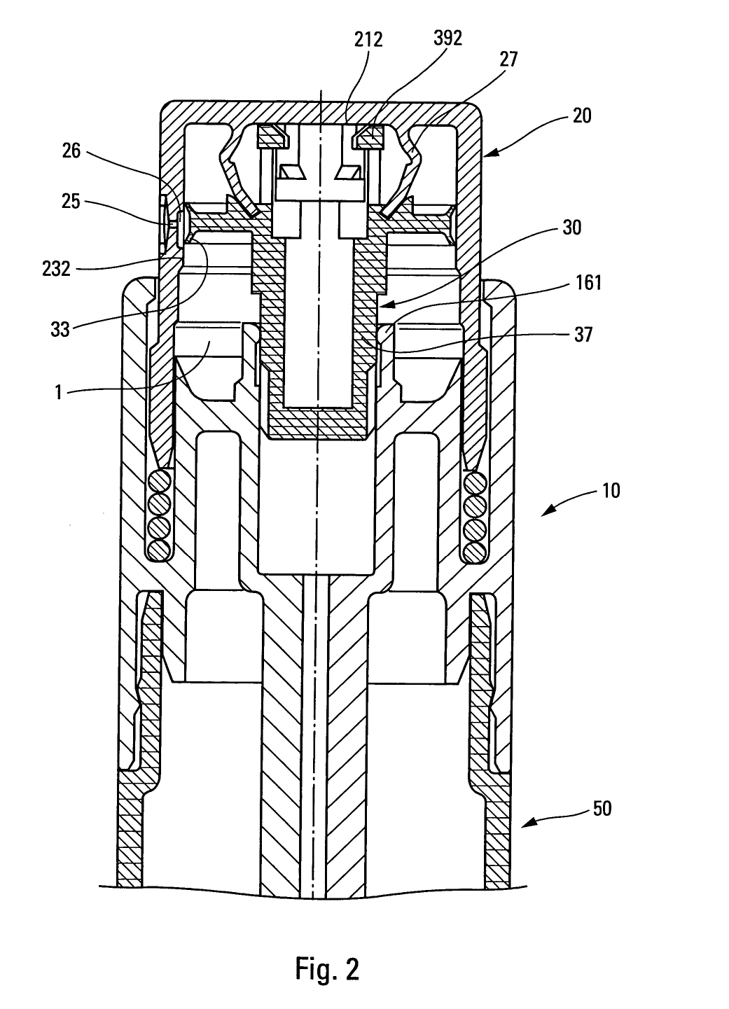

The embodiment of the dispenser member of the invention shown in FIGS. 1 and 2 is shown in association with a receptacle 50 defining an opening in the form of a neck 53 which advantageously has a fixing profile on its outside surface. The receptacle 50 internally defines a fluid reservoir 5.

The dispenser member comprises three component elements, namely a body 10, a pusher 20, and a piston member 30. All three parts can be made of a plastics material by injection molding.

The body 10 has a fixing ring 11 that co-operates with the neck 53 of the receptacle 50. More precisely, the ring 11 comes into engagement around the neck 53. The body 10 can also be provided with a self-sealing lip 12 in sealing contact with the inside wall of the neck 53. A guide band 14 can extend in alignment with the fixing ring 11. At its top end, the ring 14 is provided with an inwardly-extending rim 141 whose function is given below. The body 10 is also provided with a bushing 13 which extends concentrically inside the guide band 14. Thus, an annular space is created between the band 14 and the bushing 13. The top end of the bushing 13 forms a main piston 133 in the form of a sealing lip. The body 10 is also provided with a inlet sleeve 16 which extends concentrically inside the bushing 13. The top end of the sleeve 16 forms a valve profile or seat 161. In addition, the body 10 integrally forms a dip tube 15 which extends into the receptacle 50. The dip tube internally defines an inlet duct 18 which extends to inside the inlet sleeve 16.

The pusher 20 has a push wall 21 and a peripheral skirt 22. The skirt 22 is connected to the push wall 20 at its outer periphery. The push wall 21 has a push outside surface 211 and an inside surface 212. The push wall 21 and the skirt 22 are in the general shape of an upside-down cup with the end-wall of the cup formed by the push wall 21 and the cylindrical side wall formed by the skirt 22. The push wall 21 is provided with spring means in the form of elastically deformable tabs or blades 27 which extend from the inside surface 212. In addition, the push wall 21 is provided with a retaining member 28 which also extends from the inside surface 212. The retaining member 28 is provided with at least one retaining profile 281 having a retaining edge facing the inside surface 212. In practice, the retaining member can be provided with a plurality of retaining profiles formed on the outside of a column extending downwards from the push wall 21.

The skirt 22 is provided with a dispensing wall 23 and with a guide wall 24.

The dispensing wall 23 is connected via its top end to the outer periphery of the push wall 21. The guide wall 24 is connected via its top end to the bottom end of the dispensing wall 23. The dispensing wall 23 is provided with an outside surface and with an inside surface 232. The inside surface is cylindrical at least in part so as to constitute a leaktight slide cylinder. The inside wall 232 is advantageously provided with a swirl system 26 which forms a recessed network in the cylindrical surface 232. This swirl system can comprise one or more swirl channels and a swirl chamber. In addition, the dispensing wall 23 is provided with a dispensing orifice which passes through the wall so as to extend from the inside surface to the outside surface. The dispensing orifice 25 is centered relative to the swirl system 26.

The guide wall 24 is engaged in the annular space formed between the guide band 14 and the bushing 13. The guide wall forms a shoulder 241 serving to come into abutment under the inwardly-extending rim 141 of the band 14. Advantageously, the inside surface 242 of the guide wall 24 forms a main cylinder inside which the main piston 133 can be moved in leaktight contact. The guide wall 24 is urged by a spring 40 which pushes the shoulder 241 against the inwardly-extending rim 141. The spring 40 can advantageously be formed integrally with the pusher in alignment with the guide wall 24. Thus, the main piston 133 can slide inside the pusher, or more precisely inside the guide wall 24 which internally forms the main cylinder 242.

In this example, the piston member 30 forms a differential piston associated with a moving inlet valve member. The piston member 30 has a disk 31 which, at its outer periphery, forms two sealing lips 32 and 33. The disk 31 and its two lips together form the differential piston. In the rest position shown in FIG. 1, the top lip 32 is positioned above the swirl system, whereas the bottom lip 33 is positioned below the swirl system. Thus, the swirl system cannot communicate with the inside of the pusher. In addition, the disk 31 forms an annular recess 311 serving to receive the free ends of the elastically deformable tabs 27 formed by the push wall 21. Furthermore, the piston member 30 forms a fastening element 39 which extends from the disk 31 towards the push wall 21. Said fastening element 39 is provided with fastening heads 392 situated at the ends of tabs 391. The fastening heads 392 are in engagement between the inside wall 212 and the retaining profiles 281 formed by the retaining member 28. Thus, the heads can move over a limited stroke between the retaining profiles and the inside surface of the push wall. However, the elastically deformable tabs 27 urge the piston member 30 away from the push wall 21, so that the fastening heads 392 are pushed into engagement with the retaining profiles 281. The fastening heads 392 can be caused to come into contact against the inside surface 212 by flexing the elastically deformable tabs 27. Stroke-limiting means thus exist that are constituted by the retaining member co-operating with the fastening element.

The piston member 30 is thus held captive inside the pusher while being capable of moving axially over a limited stroke. However, the elastically deformable tabs 27 urge the piston member into the rest position, in which the fastening heads are in engagement with the retaining profiles. In addition, the sealing lips 32 and 33 are positioned on either side of the swirl system so as to isolate it. This corresponds to the rest position shown in FIG. 1.

In addition, the piston member 30 also forms an axial central rod 37 which, at its bottom end, has an inlet valve profile 38 which co-operates with the corresponding profile 161 in the sleeve 16 to form the inlet valve therewith. In the rest position, the inlet valve is open.

Thus, a pump chamber 1 is created between the body, the pusher, and the piston member. The pump chamber 1 is isolated from the outside by the bottom lip 33 but it communicates with the reservoir through the open inlet valve.

Starting from the rest position shown in FIG. 1, it is possible to exert pressure on the push outside surface 211 of the push wall 21. This causes the pusher and the piston member to move relative to the body. In a first stage, the inlet valve is closed due to the axial rod 37 penetrating more deeply into the sleeve 16 so as to establish sliding leaktight contact. Whereupon, the pump chamber 1 is isolated from the outside. The fluid in the pump chamber is then subjected to an increase in pressure, which causes the piston member 30 to move towards the push wall 21, against the spring force exerted by the resilient tabs 27. Thus, the bottom lip 33 moves upwards until it reaches the swirl system 26. Whereupon, the fluid finds an outlet passageway through the swirl system and through the dispensing orifice. This actuation position is shown in FIG. 2. In order to reach this position, it is necessary for the pressure inside the pump chamber to be greater than the stiffness of the elastically deformable tabs 27, which therefore act as a precompression spring. The piston member 30 can move towards the push wall 21 until the fastening heads 392 come into abutment against the inside surface 212. In this position, which is shown in FIG. 2, the bottom sealing lip 33 of the differential piston is positioned at the swirl system. As soon as the pressure inside the chamber decreases again, the piston member 30 can, once again, move away from the push wall 21 under the drive from the resilient tabs 27. Finally, the piston member 30 returns to its rest position shown in FIG. 1.

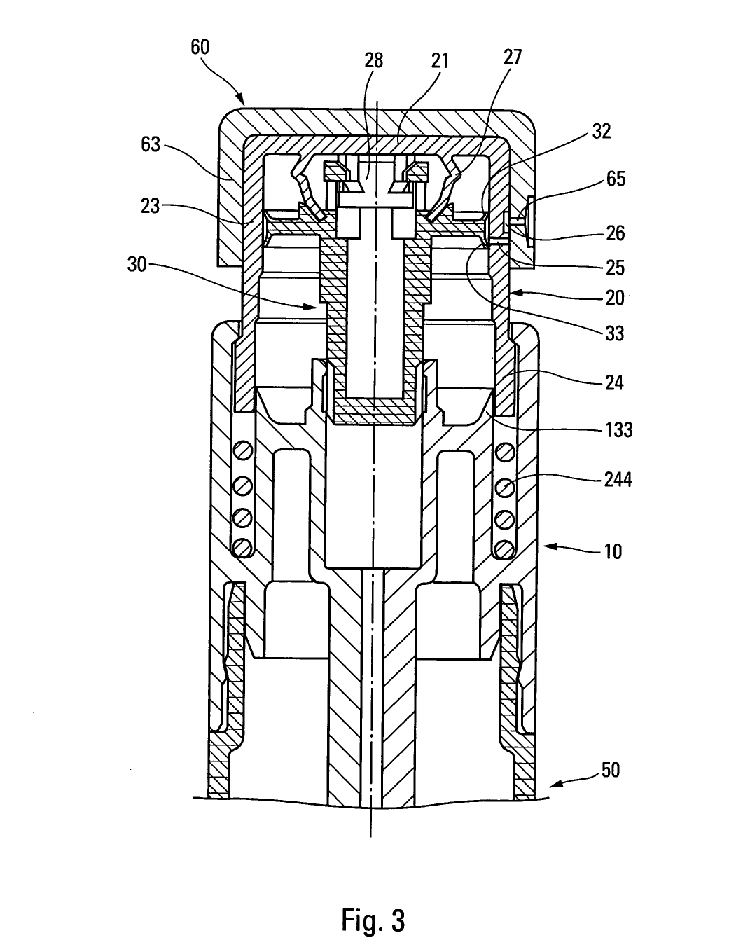

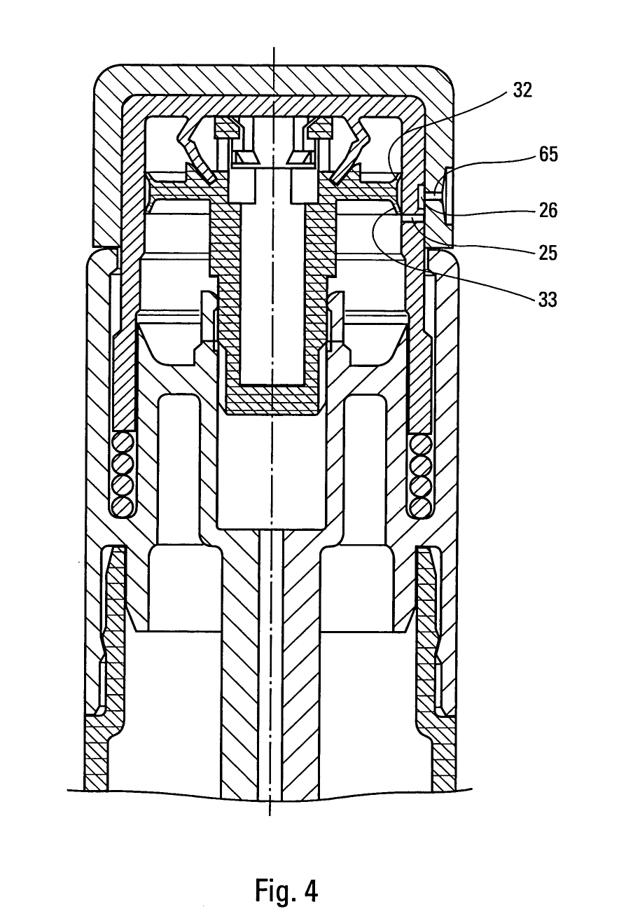

In the second embodiment shown in FIGS. 3 and 4, the receptacle 50, the body 10, and the piston member 30 can be identical to those in FIGS. 1 and 2. The pusher 20 has a dispensing wall 23 and a guide wall 24 inwardly forming a main cylinder for the main piston 133. The push wall 21 also forms elastically deformable tabs 27 and a retaining member 28. The displacement of the piston member inside the pusher 20 can be identical to that of the embodiment in FIGS. 1 and 2. However, the inside surface of the dispensing wall 23 is not formed with a swirl system, but solely with a through duct 25, which does not form the dispensing orifice. In this case, the pusher 20 is associated with a cap 60 which covers the push wall 21 and the actuating wall 23. By way of example, the pusher can be force-fitted inside the cap. The cap 60 comprises an outer peripheral ring 63 which extends concentrically around the dispensing wall 23 in clamping contact therewith. The ring 63 is formed with a dispensing orifice 65. Furthermore, the outside surface of the dispensing wall 23 is formed with a swirl system 26 which is centered on the dispensing orifice 65.

The piston member 30 is held captive inside the pusher while being allowed a limited degree of freedom to move axially. It should also be noted that the precompression spring is formed integrally with the pusher. In addition, the piston member being held captive, and its movement being limited are achieved entirely by the pusher and by the piston member, without any additional part being necessary.

1. A fluid dispenser member designed to be associated with a fluid reservoir (50) and comprising:
a chamber (1) in which the fluid is put under pressure, the chamber being provided with an inlet valve (161, 38) and with an outlet;
a dispensing orifice (25);
a main piston (133) in leaktight sliding contact inside a main cylinder (242) for the purpose of causing the volume of the chamber to vary;
a pusher (20) that can be actuated to generate relative movement between the main piston and the main cylinder; and
a differential piston (31, 32, 33) in leaktight sliding contact inside the pusher for the purpose of selectively unmasking the outlet of the chamber;
said dispenser member being characterized in that it further comprises stroke-limiting means (28, 39) for limiting the stroke of the differential piston in the pusher, said stroke-limiting means being provided between the pusher and the differential piston.

2. A fluid dispenser member according to claim 1, in which the pusher comprises a push wall (21) that can be pressed to actuate the pusher along an actuating axis (X), and a substantially cylindrical peripheral skirt (22), the differential piston being in leaktight sliding contact with the slide cylinder formed by the inside surface (232) of the skirt.

3. A fluid dispenser member according to claim 2, in which the stroke-limiting means comprise a retaining member (28) formed at the push wall and a fastening element (39) formed by the differential piston, said fastening element being in engagement with the retaining member so as to enable the differential piston to move axially over a limited stroke between a high abutment and a low abutment.

4. A fluid dispenser member according to claim 3, in which the retaining member (28) is provided with at least one retaining profile (281), and the fastening element (39) is provided with at least one fastening head (392) suitable for coming into engagement with said at least one retaining profile in the low abutment position.

5. A fluid dispenser member according to claim 3, in which the push wall has a push outside surface (211) and an inside surface (212), the fastening element (39) coming into high abutment against said inside surface.

6. A fluid dispenser member according to claim 3, in which the differential piston has a disk (31) defining an outer periphery forming at least one sealing lip (32, 33) in leaktight sealing contact with the cylinder of the skirt, the fastening element extending from the disk towards the push wall.

7. A fluid dispenser member according to claim 1, in which the differential piston has an axial rod (37) co-operating with the valve seat (161) for forming said inlet valve therewith.

8. A fluid dispenser member according to claim 1, in which the differential piston is urged by spring means (27) which are formed integrally with the pusher.

9. A fluid dispenser member according to claim 8, in which the spring means comprise elastically deformable tabs (27).

10. A fluid dispenser member according to claim 1, having a return spring (244) urging the pusher into the rest position, said spring being formed integrally with the pusher.
